(19) United States
(12) Patent Application Publication
(10) Pub. No.: US 2002/0093731 A1
(43) Pub. Date: Jul. 18, 2002

(54) Semiconductor optical amplifier

(75) Inventors: Craig Tombling, Oxford (GB); Alistair Henderson Kean, Oxford (GB); Martin David Dawson, Glasgow (GB); Anthony Edward Kelly, Glasgow (GB)

Correspondence Address: LAHIVE & COCKFIELD, 28 STATE STREET, BOSTON, MA, 02109, US

(73) Assignee: Kamelian Limited, Oxford (GB)

(21) Appl. No.: 10/045,175

(22) Filed: Jan. 11, 2002

(30) Foreign Application Priority Data
Jan. 13, 2001 (GB) 0100976.0

(51) Int. Cl. H01S 3/00

(52) U.S. Cl. 359/344

(57) ABSTRACT

A semiconductor optical amplifier comprising an active gain region of the (In, Ga)(As, N) system is proposed, together with the use of (Ga,In)(As,N) as the base material for the fabrication of an SOA, and a semiconductor optical amplifier comprising (Ga,In)(As,N) as the base material. The N content of the (In,Ga)(As,N) can be varied along a dimension of the active region in the direction of propagation of light signals therein, to create a varying bandgap such as for mode expanders. The active region can be supplied by a source of electrical bias which is applied in segments along the dimension of the active region, the segments being capable of independent variation. This should allow channel equalisation of WDM signals to be performed dynamically. This scheme could also be used to equalise device parameters such as differential gain, saturation output power and linewidth enhancement factor across the amplification bandwidth.

### FIELD OF THE INVENTION

The present invention relates to Semiconductor Optical Amplifiers (SOAs) devices. In particular, it proposes the use of the GaInNAs material system in this context. The invention flows from the discovery that the use of this material system should allow a number of novel devices to be fabricated which would not be feasible using the previous materials systems such as InP.

### BACKGROUND ART

Semiconductor optical amplifiers are optoelectronic devices, which use gain in a device to amplify the intensity of an optical signal. The wavelengths of light which are presently of interest are between 1200 and 1600 nm. This is because the transmission through optical fibres is maximised at specific wavelength ranges, which lie between 1.2 and 1.6 μm. The SOAs are fabricated from the groups III and V elements from the periodic table. In order to amplify light between 1.2 and 1.6 μm the group III and V elements which are typically used are gallium (Ga) and indium (In), (both group III), and arsenic (As) and phosphorus (P), (both group V). These materials are doped with impurities from other columns of the periodic table to allow electrical activity, which in turn generates light via the recombination of an electron from a conducting state to an insulating state.

The devices are above are referred to as being of the (Ga,In)(As,P) material group. SOAs fabricated from this material system have been demonstrated. However, the performance of the devices is limited by several undesirable properties of this particular material system. The energy of the conduction band of the semiconductor bandgap is controlled by varying the composition of the (Ga,In)(As,P) alloy. The substrate on which these materials are formed is indium phosphide (InP). The (Ga,In)(As,P) alloy must be closely lattice matched to InP otherwise the grown layer (the epilayer) will collapse due to excess strain. The electronic bandgap is varied by relative molar fractions of Ga,In,As and P, whilst maintaining the overall lattice constant close to that of InP. Taking the above constraints into account it is found that the conduction band discontinuity (ΔE_{c}) of GaInAsP—InP lasers is smaller than that of the more conventional AlGaAs—GaAs lasers (which emit at shorter wavelengths). Electrons in the conduction band are confined in a so-called active region by varying the conduction band so that there is an energy minimum at a designed position in the device.

At this position it is possible for electrons to recombine and produce a photon. If they have too much energy, or are not confined well enough then they will escape from the active region before recombination, and a photon will not be produced. This is known as carrier escape and is illustrated schematically in FIG. 1. The electrons in the active region gain energy through an applied electric potential. The confinement energies available in this material system are such that it is possible for the electron to have sufficient energy as not to be confined in the active region. This has the effect of lowering the efficiency of the device in such a way that more electrons have to be injected to produce sufficient light output.

If the temperature of the device is increased then the electron may gain additional kinetic energy. The magnitude of the electronic bandgap is inversely proportional to temperature. This means that the confinement energy in the active region decreases at higher temperature leading to increased electron escape and associated reduction of efficiency, which in turn means higher injection currents are required, which again increase the temperature of the device. This positive feedback mechanism leads to inefficient devices (FIG. 2).

One of the solutions to this mechanism is to increase the conduction band offsets. It is possible to achieve this by changing the basic materials of the device. One material system of interest is (In,Ga)(As), on GaAs substrates. This system can achieve higher bandgap offsets than (In,Ga)(As,P). However, strain is introduced by the addition of In to the alloy. Another material system, recently investigated is (Ga,In)(As,N) on GaAs. There is a minimal amount of strain introduced by the addition of nitrogen, however the advantage of this system is that a relatively small amount of nitrogen is added (<6%) to produce a comparatively large change in bandgap. The refractive index of GaAs based active layers is around 3.37. This means that the waveguiding properties of InGaAsN embedded in GaAs will be different from (In,Ga)(As,P) embedded in InP.

To date, SOA technology is mature in the InP material system at a wavelength of 1.55 μm. Indeed research into SOAs has been performed worldwide since the 1980s. InP based devices, however, have a number of limitations as explained above.

### SUMMARY OF THE INVENTION

We have identified a number of advantages of the (In,Ga)(As,N) system as a materials system for SOAs over InP, particularly at wavelengths in the 1.55 μm region.

First, the bandgap, and therefore emission wavelength and refractive index of the material is a strong function of the effective nitrogen content in the alloy. As a result, material may be created where the electronic bandgap varies along a dimension of the device in the direction of propagation of light signals therein. This may be achieved by either a modified epitaxial growth process, or by post epitaxial growth processing, which may include thermal annealing.

Second, InP (the substrate and waveguide buffer material) has a refractive index of 3.16 at 1.55 mm. The active material in this system, typically (In,Ga)(As,P), has an index of 3.58 at the same wavelength. This results in very tightly confined optical modes in (In,Ga)(As,P) waveguided devices. In the case of (Ga,In)(As,N) the substrate and waveguide material is GaAs based and has a refractive index around 3.37. The active material will have an index (as in (In,Ga)(As,P) of 3.58). Therefore the optical mode in (Ga,In)(As,N) based devices will be much less tightly confined.

Finally, multiple quantum well active regions using this material system have an inherently larger conduction band offset than those in InP. This results in greater electron confinement and thus much improved high temperature performance.

The present invention therefore provides a semiconductor optical amplifier comprising an active gain region of the (In,Ga)(As,N) system.

The invention also proposes the use of (Ga,In)(As,N) as the base material for the fabrication of an SOA.

Preferably, the N content of the (In, Ga)(As, N) varies along a dimension of the active region in the direction of propagation of light signals therein.

It is also preferred that the active region is supplied by a source of electrical bias which is applied in segments along the dimension of the active region, the segments being capable of independent variation.

Thus, the present invention permits the characteristics of the (In,Ga)(As,N) system to be harnessed in the following ways to create novel devices.

The bandgap of the active region can be longitudinally varied along the device. This can be used to create SOAs which have a larger amplification bandwidth than devices with a fixed bandgap.

Furthermore, the electrical bias to the device can be arranged in sections so that the wavelength dependence of the amplification can be adjusted by the changing the bias to each of the sections. This should allow channel equalisation of WDM signals to be performed dynamically. This scheme could also be used to equalise device parameters such as differential gain, saturation output power and linewidth enhancement factor across the amplification bandwidth.

Preferably the effect of the presence of nitrogen can be modified along a dimension of the device in the direction of propagation of light signals therein. The modification may take the form of a continuous, or a stepped variation of the effect.

As previously mentioned the optical mode in (In,Ga)(As,N) based devices will be much more dilute. This means that for any given modal optical power the local intensity will be lower than in InP. This should result in SOA devices with higher output powers.

### BRIEF DESCRIPTION OF THE DRAWINGS

Embodiments of the invention will now be described with reference to the accompanying figures, in which;

FIG. 1 shows carrier escape in a device;

FIG. 2 shows the relationship between the temperature of a device and the required injection current;

FIG. 3 shows variation in bandgap, emission wavelength and refractive index with nitrogen content;

FIG. 4 shows a variation of the effect described in FIG. 3 in which the nitrogen content varies stepwise;

FIG. 5 shows a device with segmented electrical bias;

FIGS. 6a and 6b show optical mode confinement.

### DETAILED DESCRIPTION OF THE EMBODIMENTS

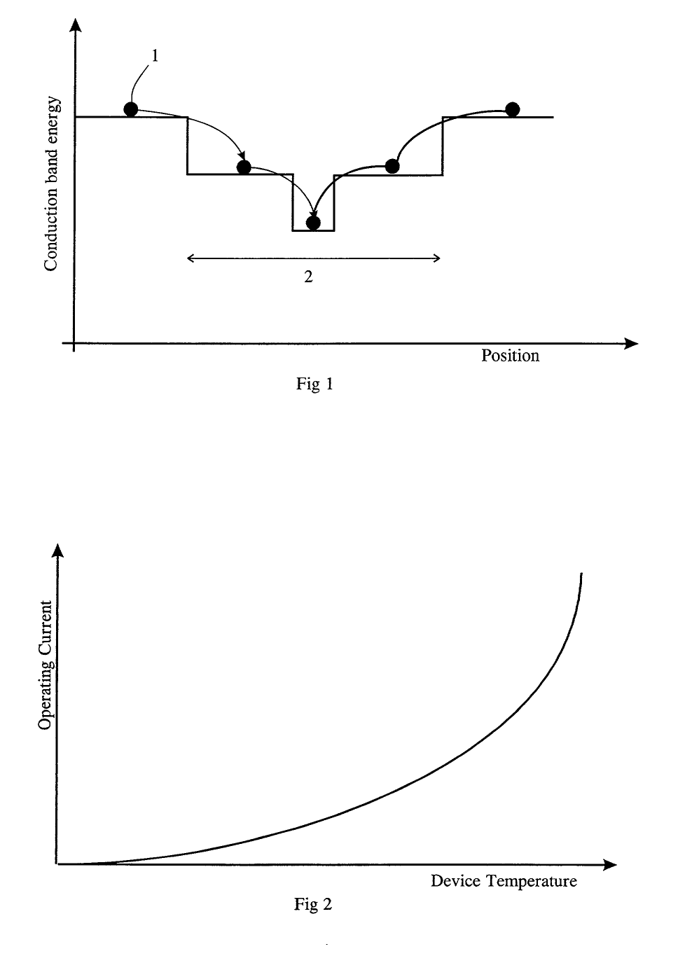

As mentioned, FIG. 1 shows carrier escape. If the conduction band offsets are not sufficiently high then it is possible for the electron 1 to be transported through the active region 2 of the device before recombination to the valence band can occur.

FIG. 2 shows the effect of temperature. If the temperature of the device is increased then the electron may gain additional kinetic energy. However, the magnitude of the electronic bandgap is inversely proportional to temperature, meaning that the confinement energy in the active region decreases at higher temperature leading to increased electron escape and associated reduction of efficiency. This in turn means higher injection currents are required, which again increase the temperature of the device. This positive feedback mechanism leads to inefficient devices.

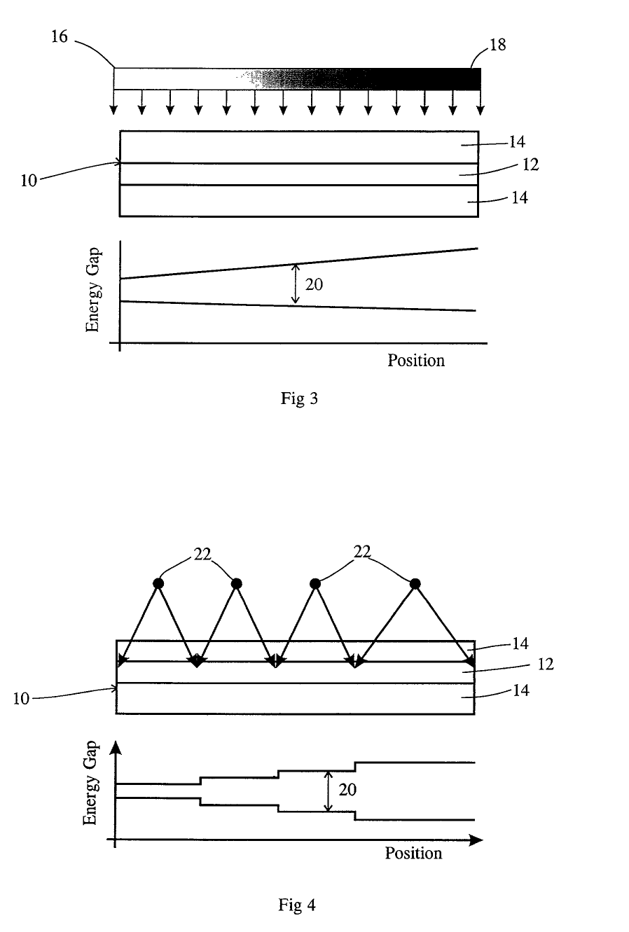

FIG. 3 shows how the bandgap, and therefore emission wavelength and refractive index of the material is a strong function of the effect of nitrogen content in the alloy. The device 10 consists of a (In,Ga)(As,N) active region 12 with cladding layers 14 on either side. The device 10 is subjected to a fabrication process whose density varies along its length from a low density at one end 16 to a high density at the other end 18. As a result material may be created where the electronic bandgap 20 varies along a dimension of the device, ideally in the direction of propagation of light signals therein. This may be achieved by either a modified epitaxial growth process, or by post epitaxial growth processing.

Thus, the bandgap of the active region can be longitudinally varied along the device. This can be used to create SOAs which have a larger amplification bandwidth than devices with a fixed bandgap where the amplification bandwidth is limited to around 80 nm. The variation can either be continuous (FIG. 3), or stepwise (FIG. 4) depending on the processing step.

In FIG. 4, a similar device 10 is grown by deposition from a plurality of separate sources 22, in this case four. Each operates at a distinct density and a stepwise variation in bandgap 20 is thereby created.

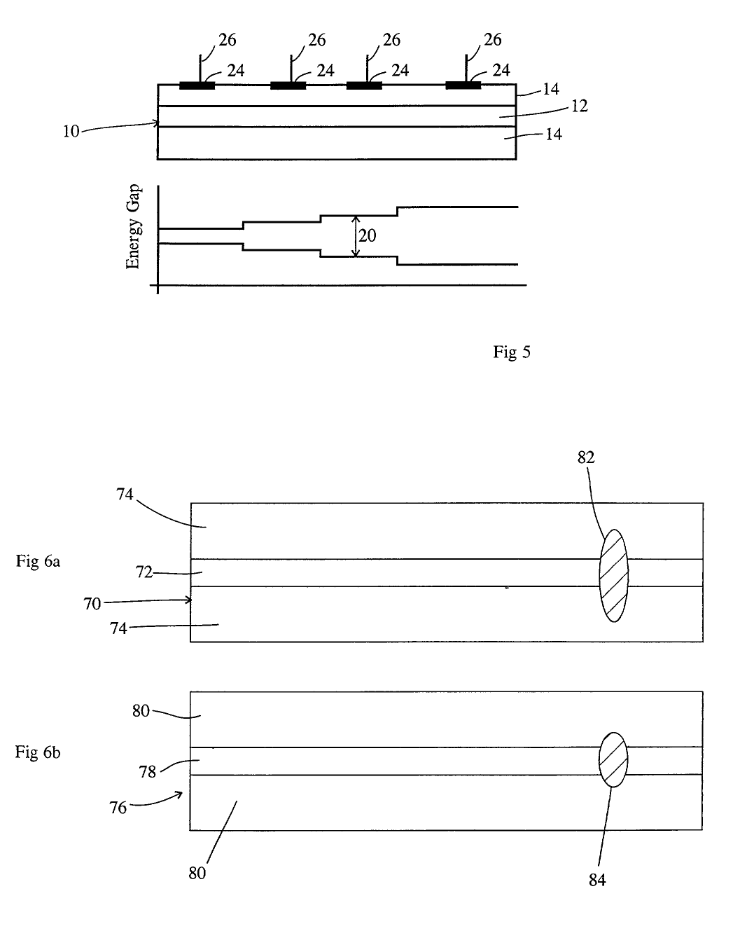

Furthermore, the electrical bias to the device can be arranged in sections so that the wavelength dependence of the amplification can be adjusted by changing the bias to each of the sections. FIG. 5 shows the device 10 of FIG. 4 with an electrode 24 provided for each of the stepwise bandgap regions. Each is powered separately by individual lead lines 26. This will allow channel equalisation of WDM signals to be performed dynamically. This scheme could also be used to equalise device parameters such as differential gain, saturation output power and linewidth enhancement factor across the amplification bandwidth.

As previously mentioned the optical mode in (Ga,In)(As,N) based devices will be much more dilute as shown in FIGS. 6a and 6b. FIG. 6a is a device 70 comprising an active layer 72 of (In,Ga)(As,N) with a refractive index of 3.58 and cladding layers 74 of GaAs with refractive index 3.37. FIG. 6b is a similar device 76 in which the active layer 78 is GaInAsP with a refractive index of 3.58 clad with InP layers 80 with a refractive index of 3.16. The smaller refractive index step between the (In, Ga)(As, N) active layer 72 and its cladding layers 74 will result in a more diffuse optical mode 82 than the mode 84 of the device 76.

This means that for any given modal optical power the local intensity will be lower than in (In,Ga)(As,P). This should result in SOA devices with higher output powers since a higher gain can be imposed without saturation.

It will of course be appreciated that many variations may be made to the above-described embodiments. In particular, the described embodiments are schematic in nature and will typically be incorporated as part(s) of a larger device.

1. A semiconductor optical amplifier comprising an active gain region of the (In,Ga)(As,N) system.

2. A semiconductor optical amplifier according to claim 1 in which the N content of the (In,Ga)(As,N) varies along a dimension of the active region in the direction of propagation of light signals therein.

3. A semiconductor optical amplifier according to claim 1 in which the active region is supplied by a source of electrical bias which is applied in segments along the dimension of the active region, the segments being capable of independent variation.

4. A semiconductor optical amplifier according to claim 1 in which the bandgap of the active region varies longitudinally along the device.

5. A semiconductor optical amplifier according to claim 1 in which the electrical bias to the device is arranged in sections so that the wavelength dependence of the device amplification can be adjusted by changing the bias to each of the sections.

6. A semiconductor optical amplifier comprising (Ga,In)(As,N) as the base material.

7. A semiconductor optical amplifier according to claim 6 in which the N content of the (In,Ga)(As,N) varies along a dimension of the active region in the direction of propagation of light signals therein.

8. A semiconductor optical amplifier according to claim 6 in which the active region is supplied by a source of electrical bias which is applied in segments along the dimension of the active region, the segments being capable of independent variation.

9. A semiconductor optical amplifier according to claim 6 in which the bandgap of the active region varies longitudinally along the device.

10. A semiconductor optical amplifier according to claim 6 in which the electrical bias to the device is arranged in sections so that the wavelength dependence of the device amplification can be adjusted by changing the bias to each of the sections.

11. The use of (Ga,In)(As,N) as the base material for the fabrication of an semiconductor optical amplifier.
